(19) United States
(12) Patent Application Publication
(10) Pub. No.: US 2022/0024370 A1
(43) Pub. Date: Jan. 27, 2022

(54) ILLUMINATION APPARATUS FOR A MOTOR VEHICLE

(71) Applicant: Hella GmbH & Co. KGaA, Lippstadt (DE)

(72) Inventors: Florian HEROLD, Bielefeld (DE); Ingo MOELLERS, Rietberg (DE); Alexander SCHWAN, Kamen (DE); Ingo STEINER, Dortmund (DE); Martin WUELLER, Warendorf (DE); Thomas Christian STORMS, Lippstadt (DE)

(73) Assignee: Hella GmbH & Co. KGaA, Lippstadt (DE)

(21) Appl. No.: 17/499,400

(22) Filed: Oct. 12, 2021

Related U.S. Application Data
(63) Continuation of application No. PCT/EP2019/079793, filed on Oct. 31, 2019.

(30) Foreign Application Priority Data
Apr. 12, 2019 (DE) 10 2019 109 743.6

(51) Int. Cl. B60Q 1/00; F21S 41/153; F21S 41/663; B60Q 1/50

(52) U.S. Cl. CPC B60Q 1/0041; F21S 41/153; F21Y 2115/10; B60Q 1/50; F21S 41/663

(57) ABSTRACT

A lighting device for a motor vehicle, in particular a headlamp device for a motor vehicle, comprising a first headlamp, which includes a first light module for generating a first light distribution as well as a second light module for generating a second light distribution, the first light distribution of the first headlamp having a higher resolution than the second light distribution of the first headlamp, as well as comprising a second headlamp, which includes a first light module for generating a first light distribution as well as a second light module for generating a second light distribution, the first light distribution of the first headlamp having a higher resolution than the first light distribution of the second headlamp and than the second light distribution of the second headlamp.

### This nonprovisional application is a continuation of International Application

No. PCT/EP2019/079793, which was filed on Oct. 31, 2019, and which claims priority to German Patent Application No. 10 2019 109 743.6, which was filed in Germany on Apr. 12, 2019, and which are both herein incorporated by reference.

### BACKGROUND OF THE INVENTION

### Field of the Invention

The present invention relates to a lighting device for a motor vehicle, in particular a headlamp device for a motor vehicle, as well as a lighting device for a motor vehicle, in particular a headlamp device for a motor vehicle.

### Description of the Background Art

A lighting device is known from EP 2 690 351 A2, which corresponds to US 2014/0029289. The headlamp device described therein comprises a first headlamp, which has a first light module for generating a first light distribution as well as a second light module for generating a second light distribution. The headlamp device further comprises a second headlamp, which has a first light module for generating a first light distribution as well as a second light module for generating a second light distribution. The first light modules of the headlamps are each designed as high-resolution light modules, the first light distributions of the headlamps each having a higher resolution than the second light distributions. Headlamps which include high-resolution light sources are expensive, have a complex structure, and are complex in terms of their operation.

Another lighting device is known from DE 10 2013 224 152 A1. The headlamp device described therein comprises a first headlamp and a second headlamp, which each have a high-beam module and a low-beam module. The two low-beam modules are configured to carry out a welcome scenario. When the driver approaches with the key to the motor vehicle, the low-beam modules are turned on, the resulting light cone, for example, being moved upward from below to indicate a wakeup.

### SUMMARY OF THE INVENTION

It is therefore an object of the present invention to provide a lighting device, which is cost-effective despite the possibility of generating a high-resolution light distribution. The object of the present invention is furthermore to provide a lighting device which may be used more flexibly.

In an exemplary embodiment, it is provided that the first light distribution of the first headlamp has a higher resolution than the first light distribution of the second headlamp and than the second light distribution of the second headlamp. It is therefore possible to optimize one of the two headlamps with regard to cost and to optimize the other of the two headlamps with regard to graphics capability. It therefore permits the use of different high-resolution light modules in the first and second headlamps from the first light module in each case to save costs in the overall system. The control electronics may also be simplified because, for example, fewer pixels overall need to be calculated than in two light modules which both have a high resolution.

The two headlamps are, for example, a headlamp installed in the right front of the vehicle and a headlamp installed in the left front of the vehicle. Either the right or the left headlamp may have a higher-resolution first light distribution.

It may be provided that the first light distribution of the second headlamp has a higher resolution than the second light distribution of the second headlamp.

It is possible that the first light module of the first headlamp and/or the first light module of the second headlamp comprise(s) a light source, preferably a high-resolution light source, in particular the light source including a solid-state LED array or a high-resolution LED matrix or elements for the high-resolution light modulation, such as a digital micromirror device (DMD) or an LCoS or an LC display. All of these elements permit the generation of a high-resolution light distribution. According to the invention, however, the first light distribution of the first headlamp has a higher resolution than the first light distribution of the second headlamp.

It may be provided that the first light module of the first headlamp and the first light module of the second headlamp may each generate a multiplicity of individually controllable light points.

The number of light points individually controllable by the first light module of the first headlamp may be greater than 2,000, in particular greater than 5,000, preferably approximately equal to 10,000 or greater than 10,000. In particular, the first light module of the first headlamp may comprise a solid-state LED array for this purpose, which may generate, in particular, 10,000 or more individually controllable light points.

The number of light points individually controllable by the first light module of the second headlamp may be less than 1,000, in particular less than 200, preferably approximately equal to 100 or less than 100. In particular, the first light module of the second headlamp may comprise an LED matrix for this purpose, which includes, in particular, two rows of light-emitting diodes, the LED matrix preferably comprising 84 or 100 individual light-emitting diodes (LEDs), which may generate 84 or 100 individually controllable light points.

The costs may be reduced hereby, in particular in comparison with a headlamp system with two identical headlamps, which each include a solid-state LED array. The resolution may be improved overall compared to headlamp systems, which each include two LED matrix system of, for example, 100 light-emitting diodes each.

It is possible that the second light module of the first headlamp and the second light module of the second headlamp have the same design or comprise light sources of the same design.

It may be provided that the second light module of the first headlamp and/or the second light module of the second headlamp comprise(s) an LED module, which includes fewer than 20, in particular fewer than 10, light-emitting diodes, or that the second light module of the first headlamp and/or the second light module of the second headlamp comprise(s) an LED matrix module or another high-resolution light source. However, they should have a lower resolution than the first light modules.

It is clear on the whole that those skilled in the art are free to choose the light sources and modules, provided that the first light module of the first headlamp has a higher resolution than the first light module of the second headlamp.

It is entirely possible that the first headlamp and/or the second headlamp comprise(s) more than two light modules.

It is also provided that the light module or the first light distribution of the first projector device performs a function which is different than the function of the light module or the second light distribution of the second projector device. The lighting device may be more flexibly designed thereby. The two light modules may preferably be operated entirely independently of each other, the light modules, in particular, generally not being operated simultaneously.

The projector devices may be designed as headlamps, the two headlamps being, in particular, a headlamp installed in the right front of the vehicle and a headlamp installed in the left front of the vehicle. Alternatively, the projector devices or the light modules of the projection devices may also be arranged in other areas of the motor vehicle, in particular of the vehicle front, and the beam path between the light module and the area in front of the vehicle should preferably not be shaded at the selected position.

In may be provided that, in the non-operating state of the projector devices, the outer appearances of the projector devices correspond to each other or are symmetrical with respect to a symmetry plane situated therebetween, and/or that, in the operating state of the projector devices, the outer appearances of the projector devices correspond to each other or are symmetrical with respect to a symmetry plane situated therebetween. Due to the appearances of the projector devices, which do not differ from each other in the non-operating state, a user is given the impression that the projector devices, in particular the headlamps, are of the same design. It is possible that, during vehicle operation, a slight illumination of the projector devices is effectuated by the light modules, so that they also do not differ from each other in the operating state.

It may be provided that the illumination range of the first light distribution is different than the illumination range of the second light distribution. Functions of the two modules, which differ significantly from each other, may be implemented thereby.

For example, it is possible that the light module or the first light distribution of the first projector device performs a driver assistance function and/or that the light module or the second light distribution of the second projector device performs the function of a near-field projection. The light module or the first light distribution performing the driver assistance function may, in particular, form the headlamp light distribution during vehicle operation, which may take place, for example, by symbols or hot spots or the like. The light module or the second light distribution performing the near-field projection may project, in particular, vehicle- or user-specific information into the area directly in front of the vehicle, preferably welcome scenarios or announcements of next maneuvers during automated operation, for example a maneuver of leaving a parking space. The illumination range of the second light distribution is therefore not necessarily in the field of vision of the driver or the occupants of the motor vehicle.

It is possible that the light module of the first projector device and/or the light module of the second projector device comprise(s) an imaging element, for example a solid-state LED array or an LED matrix or a digital micromirror device or an LCoS or an LC display. Finally, each of these elements may be used in the light modules.

It may be advantageous if the first and second projector devices are largely based on equivalent parts to reduce the manufacturing complexity. The projector devices may comprise, in particular, equivalent parts in the area of optics, electronics, thermal management and mechanics.

Further scope of applicability of the present invention will become apparent from the detailed description given hereinafter. However, it should be understood that the detailed description and specific examples, while indicating preferred embodiments of the invention, are given by way of illustration only, since various changes, combinaitons, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic front view of a motor vehicle, including a first specific embodiment of a lighting device according to the invention; and

FIG. 2 shows a perspective view of a front of a motor vehicle, including a specific embodiment of a lighting device according to the invention, from which the light distributions emanate with different illumination ranges.

### DETAILED DESCRIPTION

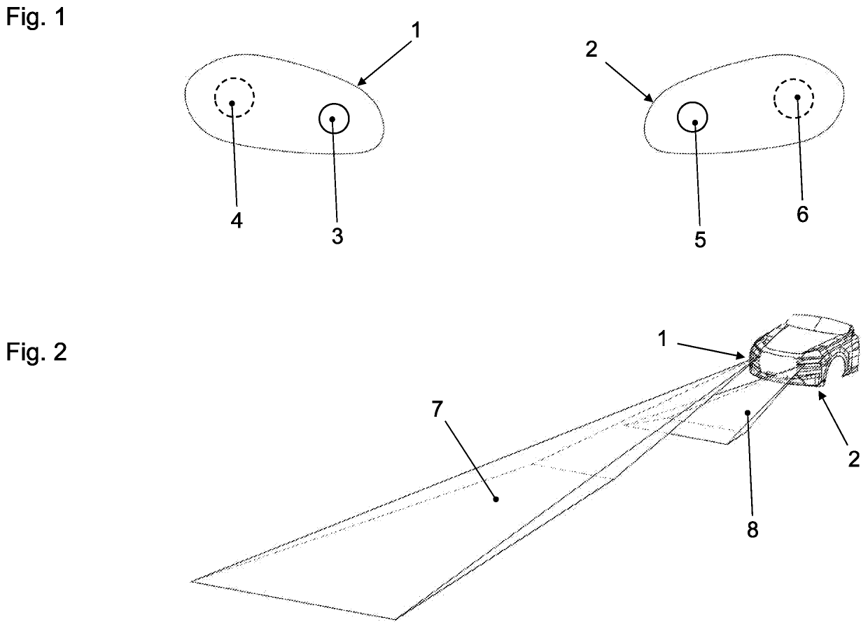

A specific embodiment of a lighting device designed as a headlamp device of a motor vehicle is illustrated in FIG. 1. The headlamp device comprises a first headlamp 1 and a second headlamp 2. In the illustrated specific embodiment, first headlamp 1 is arranged on the left side of the vehicle front and second headlamp 2 is arranged on the right side thereof. However, it is entirely possible that first headlamp 1 is arranged on the right side of the vehicle front and second headlamp 2 is arranged on the left side thereof.

First headlamp 1 includes a first light module 3 and a second light module 4. Second headlamp 2 also includes a first light module 5 and a second light module 6. The two second light modules 4, 6 are of the same design in the illustrated exemplary embodiment and are designed, in particular, as so-called bi-LED modules. The bi-LED module may include, for example, two light-emitting diodes (LEDs) and a corresponding optical element. The optical element may comprise, in particular, two light conductors for the light of the two light-emitting diodes.

First light module 3 of first headlamp 1 comprises a light source, which is designed as a solid-state LED array. It is an LED chip having 10,000 or possibly even more individual light sources, which are all individually controllable. Light module 3 or the light source furthermore comprises a suitable optical system.

First light module 5 of second headlamp 2 also comprises a light source, which, however, has a lower resolution than the light source of first headlamp 1 and is designed as a two-row LED matrix having 100 individual light-emitting diodes. Light module 5 or light source furthermore comprises a suitable optical system.

First light modules 3, 5 of headlamps 1, 2 illuminate the middle to far area in front of the vehicle, while second light modules 4, 6 illuminate the area in front of the vehicle. On the whole, the light distributions overlap, the overall higher-resolution light distribution of first light module 3 of first headlamp 1 overlaps the lower-resolution light distribution of first light module 5 of second headlamp 2.

A specific embodiment of a lighting device designed as a headlamp device of a motor vehicle is also illustrated in FIG. 2. The headlamp device comprises a first headlamp 1 used as a projector device and a second headlamp 2 used as a projector device. In the illustrated specific embodiment, first headlamp 1 is arranged on the left side of the vehicle front and second headlamp 2 is arranged on the right side thereof. However, it is entirely possible that first headlamp 1 is arranged on the right side of the vehicle front and second headlamp 2 is arranged on the left side thereof.

First headlamp 1 comprises a light module, which is not illustrated and which generates a first light distribution 7. Second headlamp 2 comprises a light module, which is also not illustrated and which generates a second light distribution 8. It is apparent that the illumination range of first light distribution 7 is significantly larger than the illumination range of second light distribution 8.

The light module or first light distribution 7 of first headlamp 1 performs a driver assistance function and may, in particular, form the headlamp light distribution during vehicle operation, which may take place, for example, by symbols or hot spots or the like.

The light module or second light distribution 8 of second headlamp 2 performs the function of a near-field projection and may project, in particular, vehicle- or user-specific information into the area directly in front of the vehicle. This may preferably be welcome scenarios or announcements of next maneuvers during automated operation, for example maneuvers for leaving a parking space. The illumination range of second light distribution 8 is therefore not necessarily in the field of vision of the driver or the occupants of the motor vehicle.

It is entirely possible that the light modules of headlamps 1, 2 perform functions other than the aforementioned ones, the other possible functions also being able to be functions deviating form the illumination of the roadway in front of the motor vehicle or functions which go beyond the illumination of the roadway in front of the motor vehicle.

Despite the significantly different functions of the two light modules in headlamps 1, 2, it may be ensured during the operating state as well as the non-operating state of the headlamp device that the outer appearances of the headlamps correspond to each other or are symmetrical with respect to a symmetry plane situated therebetween.

The two light modules of the two headlamps 1, 2 may be operated entirely independently of each other, the light modules, in particular, generally not being operated simultaneously.

It is entirely possible that headlamps 1, 2 comprise further light module in addition to the light modules described, which may be designed, for example, as high-beam light modules and/or as low-beam light modules and be used to illuminate the roadway.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lighting device for a motor vehicle, in particular a headlamp device for a motor vehicle, the lighting device comprising:
a first headlamp which include a first light module to generate a first light distribution as well as a second light module to generate a second light distribution, the first light distribution of the first headlamp having a higher resolution than the second light distribution of the first headlamp; and
a second headlamp, which includes a first light module to generate a first light distribution as well as a second light module to generate a second light distribution,
wherein the first light distribution of the first headlamp has a higher resolution than the first light distribution of the second headlamp and than the second light distribution of the second headlamp.

2. The lighting device according to claim 1, wherein the first light distribution of the second headlamp has a higher resolution than the second light distribution of the second headlamp.

3. The lighting device according to claim 1, wherein the first light module of the first headlamp and/or the first light module of the second headlamp comprise(s) a light source, preferably a high-resolution light source, in particular the light source including a solid-state LED array or a high-resolution LED matrix or elements for the high-resolution light modulation, such as a digital micromirror device or an LCoS or an LC display.

4. The lighting device according to claim 1, wherein the first light module of the first headlamp and the first light module of the second headlamp each generate a plurality of individually controllable light points.

5. The lighting device according to claim 4, wherein a number of light points individually controllable by the first light module of the first headlamp is greater than 2,000, greater than 5,000, approximately equal to 10,000, or greater than 10,000.

6. The lighting device according to claim 1, wherein the first light module of the first headlamp comprises a solid-state LED array, which generates 10,000 or more individually controllable light points.

7. The lighting device according to claim 4, wherein a number of light points individually controllable by the first light module of the second headlamp is less than 1,000, less than 200, approximately equal to 100. or less than 100.

8. The lighting device according to claim 1, wherein the first light module of the second headlamp comprises an LED matrix, which includes two rows of light-emitting diodes, the LED matrix comprising 84 or 100 individual light-emitting diodes, which generate 84 or 100 individually controllable light points.

9. The lighting device according to claim 1, wherein the second light module of the first headlamp and the second light module of the second headlamp have the same design or comprise light sources of the same design.

10. The lighting device according to claim 1, wherein the second light module of the first headlamp and/or the second light module of the second headlamp comprise(s) an LED module, which includes fewer than 20, or fewer than 10 light-emitting diodes, or wherein the second light module of the first headlamp and/or the second light module of the second headlamp comprise(s) an LED matrix module or another high-resolution light source.

11. A lighting device for a motor vehicle, in particular a headlamp device for a motor vehicle, the lighting device comprising:
a first projector device, in particular a first headlamp, the first projector device including a light module for generating a first light distribution, the light module or the first light distribution having a function which deviates from the illumination of the roadway in front of the motor vehicle or a function which goes beyond the illumination of the roadway in front of the motor vehicle; and
a second projector device, in particular a second headlamp, the second projector device including a light module for generating a second light distribution, the light module or the second light distribution having a function which deviates from the illumination of the roadway in front of the motor vehicle or a function which goes beyond the illumination of the roadway in front of the motor vehicle,
wherein the light module or the first light distribution of the first projector device performs a function which is different than the function of the light module or the second light distribution of the second projector device.

12. The lighting device according to claim 11, wherein, in the non-operating state of the projector devices, the outer appearances of the projector devices correspond to each other or are symmetrical with respect to a symmetry plane situated therebetween, and/or that, in the operating state of the projector devices, and wherein the outer appearances of the projector devices correspond to each other or are symmetrical with respect to a symmetry plane situated therebetween.

13. The lighting device according to claim 11, wherein the illumination range of the first light distribution is different than the illumination range of the second light distribution.

14. The lighting device according to claim 11, wherein the light module or the first light distribution of the first projector device performs a driver assistance function and/or that the light module or the second light distribution of the second projector device performs the function of a near-field projection.

15. The lighting device according to claim 11, wherein the light module of the first projector device and/or the light module of the second projector device comprise(s) an imaging element, a solid-state LED array or an LED matrix or a digital micromirror device or an LCoS or an LC display.
